(19) United States
(12) Patent Application Publication
(10) Pub. No.: US 2006/0153424 A1
(43) Pub. Date: Jul. 13, 2006

(54) Image processing apparatus and method, program code and storage medium

(75) Inventor: Junichi Hayashi, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/373,182

(22) Filed: Mar. 13, 2006

Related U.S. Application Data
(62) Division of application No. 10/127,447, filed on Apr. 23, 2002.

(30) Foreign Application Priority Data
Apr. 24, 2001 (JP) 2001-126642

(51) Int. Cl. G06K 9/00; G06K 9/36

(52) U.S. Cl. 382/100; 382/232

(57) ABSTRACT

An image processing apparatus which efficiently perform image coding and digital watermark embedding, and decoding and digital watermark extraction. For this purpose, an image is transformed to plural frequency subbands, at least one of the plural frequency subbands is selected, and in the selected frequency subband, a portion designated based on a matrix is changed, thereby digital watermark embedding is performed.

### FIELD OF THE INVENTION

The present invention relates to an image processing apparatus and its method, program code and a storage medium for generating image data where a digital watermark is embedded in original image data, and/or extracting the digital watermark from the image data.

### BACKGROUND OF THE INVENTION

In recent years, various information such as character data, image data and audio data are digitized in accordance with explosive development and wide use of computer and computer network. Digital information is not degraded due to secular change or the like and can be preserved in a complete status, on the other hand, as it can be easily duplicated, copyright protection is a big problem. Accordingly, the significance of security technology for copyright protection is rapidly increasing.

One of the copyright protection techniques is “digital watermarking”. Digital watermarking is embedding a copyright holder's name, a purchaser's ID or the like in an imperceptible form in digital image data, audio data, character data or the like, and tracking unauthorized use by illegal duplication. Since a digital watermark may come under various attacks, it must have resistance against the attacks.

Further, among these data, image data, especially multivalue image data includes a very large among of information. Upon storage or transmission of such image, a massive amount of data is handled. Accordingly, for storage or transmission of image, high efficiency coding is employed to reduce the amount of data by changing the contents of the image such that the redundancy of the image is eliminated or degradation of image quality is hardly recognizable.

As one of the high efficiency coding methods, the JPEG coding recommended by the ISO and the ITU-T as a still-image international standard coding method is widely used. In the JPEG method based on discrete cosine transform, if a compression rate is increased, block distortion occurs.

On the other hand, as image input/output devices have a high resolution in response to a requirement for improvement in image quality, a higher compression rate than the conventional rates is needed. To meet the need, a coding method utilizing discrete wavelet transform has been proposed as a conversion method different from the above discrete cosine transform.

As described above, since digital image data causes problems regarding the amount of information and security, the compression coding method is employed so as to solve the former problem and the digital watermarking is employed so as to solve the latter problem.

On the other hand, as a method as a combination of digital watermarking and image coding has not been proposed, the compression coding and the digital watermarking must be performed independently. For example, digital watermarking is performed, and then, compression coding is performed. However, this method is not efficient. Further, there is a possibility that the embedded digital watermark is deleted by a latter-stage compression coding.

The present invention has been made in view of the above problems, and has its object to provide an image processing apparatus and its method for performing a combination of the digital watermarking and an image coding method.

### SUMMARY OF THE INVENTION

In order to achieve the object of the present invention, an image processing apparatus of the present invention characterized by comprising: transform means for transforming an image into plural frequency subbands; and
digital watermark embedding means for selecting at least one frequency subband from the plural frequency subbands, and performing digital watermark embedding by changing a portion of the selected frequency subband designated based on a mask, by using a pattern array.

In order to achieve the object of the present invention, an image processing apparatus of the present invention characterized by comprising: entropy decoding means for performing entropy decoding on a code string, obtained by performing digital watermark embedding by transforming an image into plural frequency subbands and changing a portion of at least one frequency subband designated based on a mask by using a pattern array, and performing entropy coding on all the frequency subbands including the frequency subband, and obtaining plural frequency subbands; and
extraction means for selecting at least one frequency subband from the plural frequency subbands, and in the selected frequency subband, extracting a digital watermark by using the pattern array from the portion designated based on the mask.

In order to achieve the object of the present invention, an image processing apparatus of the present invention characterized by comprising: transform means for transforming an image, obtained by performing digital watermark embedding by transforming an image into plural frequency subbands and changing a portion of at least one frequency subband designated based on a mask by using a pattern array, and performing inverse frequency transform on all the frequency subbands including the frequency subband, into plural frequency subbands; and
extraction means for selecting at least one frequency subband from the plural frequency subbands, and in the selected frequency subband, extracting a digital watermark by using the pattern array from the portion designated based on the mask.

In order to achieve the object of the present invention, an image processing apparatus of the present invention characterized by comprising: extraction means for extracting a digital watermark from an image, obtained by transforming an image into plural frequency subbands, performing digital watermark embedding by performing changing in at least one frequency subband by using a first pattern array, and performing inverse frequency transform on all the frequency subbands including the frequency subband, by using a second pattern array.

In order to achieve the object of the present invention, an image processing apparatus of the present invention characterized by comprising: entropy decoding means for performing entropy decoding on a bit stream included in a code string, obtained by performing digital watermark embedding by transforming an image into plural frequency subbands and performing changing in at least one frequency subband by using a first pattern array, and performing entropy coding on all the frequency subbands including the frequency subband, and obtaining plural frequency subbands;
image generation means for reproducing the image based on the plural frequency subbands; and
extraction means for, in the image reproduced by the image generation means, performing digital watermark extraction by using a second pattern array.

In order to achieve the object of the present invention, an image processing apparatus of the present invention characterized by comprising: inverse discrete wavelet transform means for performing inverse discrete wavelet transform on a pattern array; and
digital watermark embedding means for performing digital watermark embedding by changing a portion of image data designated based on a mask by using the pattern array inverse discrete-wavelet transformed by the inverse discrete wavelet transform means.

In order to achieve the object of the present invention, an image processing method of the present invention characterized by comprising: a transform step of transforming an image into plural frequency subbands; and
a digital watermark embedding step of selecting at least one frequency subband from the plural frequency subbands, and performing digital watermark embedding by changing a portion of the selected frequency subband designated based on a mask, by using a pattern array.

In order to achieve the object of the present invention, an image processing method of the present invention characterized by comprising: an entropy decoding step of performing entropy decoding on a code string, obtained by performing digital watermark embedding by transforming an image into plural frequency subbands and changing a portion of at least one frequency subband designated based on a mask by using a pattern array, and performing entropy coding on all the frequency subbands including the frequency subband, and obtaining plural frequency subbands; and
an extraction step of selecting at least one frequency subband from the plural frequency subbands, and in the selected frequency subband, extracting a digital watermark by using a pattern array from the portion designated based on the mask.

In order to achieve the object of the present invention, an image processing method of the present invention characterized by comprising: a transform step of transforming an image, obtained by performing digital watermark embedding by transforming an image into plural frequency subbands and changing a portion of at least one frequency subband designated based on a mask by using a pattern array, and performing inverse frequency transform on all the frequency subbands including the frequency subband, into plural frequency subbands; and
an extraction step of selecting at least one frequency subband from the plural frequency subbands, and in the selected frequency subband, extracting a digital watermark by using the pattern array from the portion designated based on the mask.

In order to achieve the object of the present invention, an image processing method of the present invention characterized by comprising: an extraction step of extracting a digital watermark from an image, obtained by transforming an image into plural frequency subbands, performing digital watermark embedding by performing changing in at least one frequency subband by using a first pattern array, and performing inverse frequency transform on all the frequency subbands including the frequency subband, by using a second pattern array.

In order to achieve the object of the present invention, an image processing method of the present invention characterized by comprising: an entropy decoding step of performing entropy decoding on a bit stream included in a code string, obtained by performing digital watermark embedding by transforming an image into plural frequency subbands and performing changing in at least one frequency subband by using a first pattern array, and performing entropy coding on all the frequency subbands including the frequency subband, and obtaining plural frequency subbands;
an image generation step of reproducing the image based on the plural frequency subbands; and
an extraction step of, in the image reproduced at the image generation step, performing digital watermark extraction by using a second pattern array.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the construction of a coding apparatus according to a first embodiment of the present invention;

FIGS. 2A to 2C are block diagrams and a table explaining discrete wavelet transform;

FIGS. 3A and 3B are explanatory diagrams showing an operation of an entropy coding unit 105;

FIGS. 4A to 4D are explanatory diagrams of structures of code strings outputted from the coding apparatus of the first embodiment;

FIG. 5 is a block diagram showing the entire construction of an image processing apparatus according to the first to fourth embodiments of the present invention;

FIG. 6 is an explanatory diagram of embedding of additional information Inf using a patchwork method;

FIG. 7 is an example of pattern array;

FIG. 8 is an explanatory diagram of a method for embedding the pattern array in FIG. 7 in transform coefficients;

FIG. 9 is a block diagram showing the construction of a digital watermark embedding unit;

FIG. 10 is a flowchart showing an operation of an additional information embedding unit;

FIG. 11 is a block diagram showing the construction of an embedded position determination unit 901;

FIG. 12 is a graph showing a human visual characteristic;

FIGS. 13A and 13B are examples of mask;

FIG. 14 is a block diagram showing the schematic construction of digital watermark embedding device according to the second embodiment of the present invention;

FIG. 15 is a block diagram showing the schematic construction of a digital watermark extraction device according to the second embodiment of the present invention;

FIG. 16 is a block diagram showing the construction of the digital watermark embedding device according to the third embodiment of the present invention;

FIG. 17 is a block diagram showing the construction and the flow of processing by a digital watermark extraction unit;

FIG. 18 is an explanatory diagram showing an example where 1-bit information extraction processing is performed on the LL subband coefficient I″(x,y) in which 1-bit information is embedded as the additional information Inf;

FIG. 19 is an explanatory diagram showing an example where the 1-bit extraction processing is performed on an LL subband coefficient I″(x,y) in which 1-bit information is not embedded as the additional information Inf;

FIGS. 20 and 21 are graphs showing convolution processing;

FIG. 22 is a block diagram showing the construction of a decoding apparatus according to the first embodiment of the present invention;

FIGS. 23A and 23B are block diagrams showing the construction and processing by an inverse discrete wavelet transform unit 4305;

FIGS. 24A and 24B are explanatory diagrams showing a decoding procedure in an entropy decoding unit 4302;

FIGS. 25A and 25B are explanatory diagrams showing an image display format;

FIG. 26 is a flowchart showing a method for obtaining a reliability distance d corresponding to each bit information;

FIG. 27 is an explanatory diagram showing acquisition of image data;

FIG. 28 is an explanatory diagram showing bases used in the discrete wavelet transform;

FIG. 29 is a block diagram showing the construction of the decoding apparatus according to the fourth embodiment of the present invention for extracting a digital watermark from a code string generated by an apparatus having the construction in FIG. 1 and decoding the data to image data; and

FIG. 30 is a block diagram showing a digital watermark extraction device according to the fourth embodiment of the present invention for extracting the digital watermark from the image data generated by the apparatus having the construction in FIG. 14.

### DETAILED DESCRIPTION OF THE PREFERRED EMBODIMENTS

Preferred embodiments of the present invention will now be described in detail in accordance with the accompanying drawings.

### First Embodiment

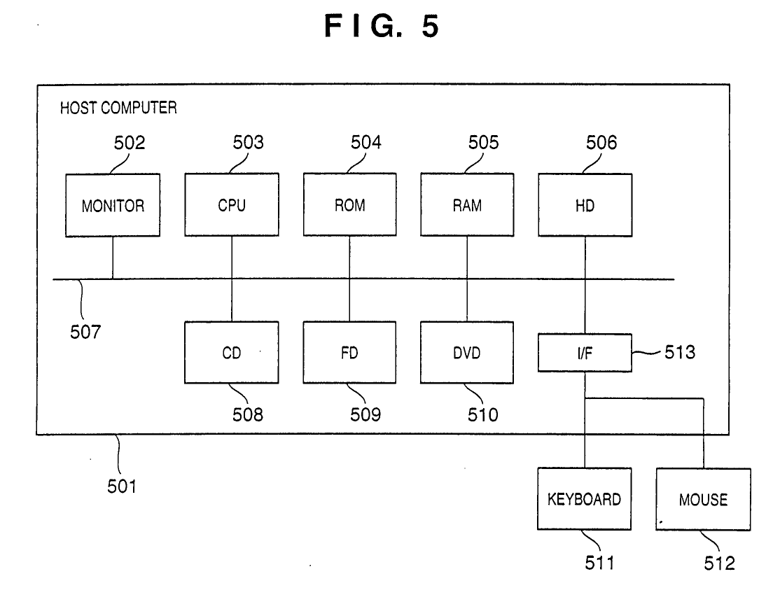

FIG. 5 is a block diagram showing the entire construction of an image processing apparatus according to the present embodiment (or embodiments to be described later). Hereinbelow, the image processing apparatus will be used as an image coding apparatus and an image decoding apparatus. In FIG. 5, a host computer 501 is a generally used personal computer.

In the host computer 501, respective blocks to be described later are interconnected via a bus 507 for transfer of various data.

In FIG. 5, reference numeral 502 denotes a monitor having a CRT, a liquid crystal display or the like for displaying images, characters and the like.

Numeral 503 denotes a CPU which controls operations of the respective blocks or performs a program stored inside.

Numeral 504 denotes a ROM in which a necessary image processing program and the like are stored in advance.

Numeral 505 denotes a RAM in which a program and/or image processing target data is temporarily stored for execution of processing by the CPU;

Numeral 506 denotes a hard disk (HD) in which a program and/or image data transferred to the RAM or the like is stored in advance, or processed image data is stored.

Numeral 508 denotes a CD drive which reads or writes data from/into a CD (CD-R) as one of external storage media.

Numeral 509 denotes an FD drive which reads or writes data from/into an FD similarly to the CD drive 508. Numeral 510 denotes a DVD drive which reads or writes data from/into a DVD similarly to the CD drive 508. Note that in a case where an image editing program or a printer driver is stored into the CD, FD, DVD or the like, the program is installed onto the HD 506 and is transferred to the RAM 505 in accordance with necessity.

Numeral 513 denotes an interface (I/F) connected to a keyboard 511 and a mouse 512 for receiving an input instruction from these devices.

<Coding Apparatus>

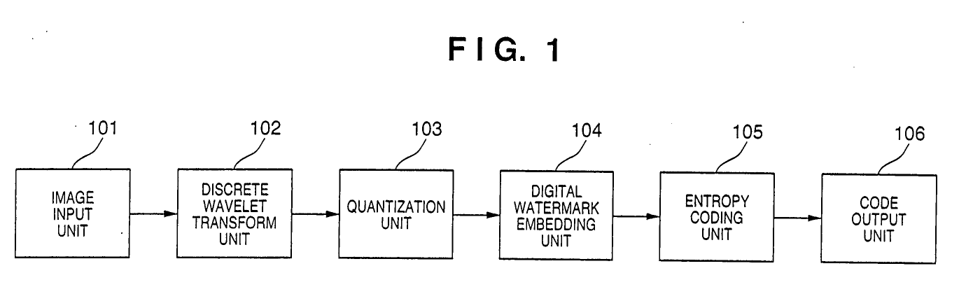

Next, the coding apparatus of the present embodiment will be described with reference to FIG. 1 showing the construction of the apparatus.

In FIG. 1, numeral 101 denotes an image input unit; 102, a discrete wavelet transform unit; 103, a quantization unit; 104, a digital watermark embedding unit; 105, an entropy coding unit; and 106, a code output unit.

First, a pixel signal constructing an image to be encoded is inputted into the image input unit 101 in raster-scan order, and an output from the image input unit 101 is inputted into the discrete wavelet transform unit 102. In the following description, the image signal represents a monochrome multivalue image. If plural color components of color image or the like are encoded, RGB color components, or luminance and chromaticity components can be compressed as the above-described monochrome color components.

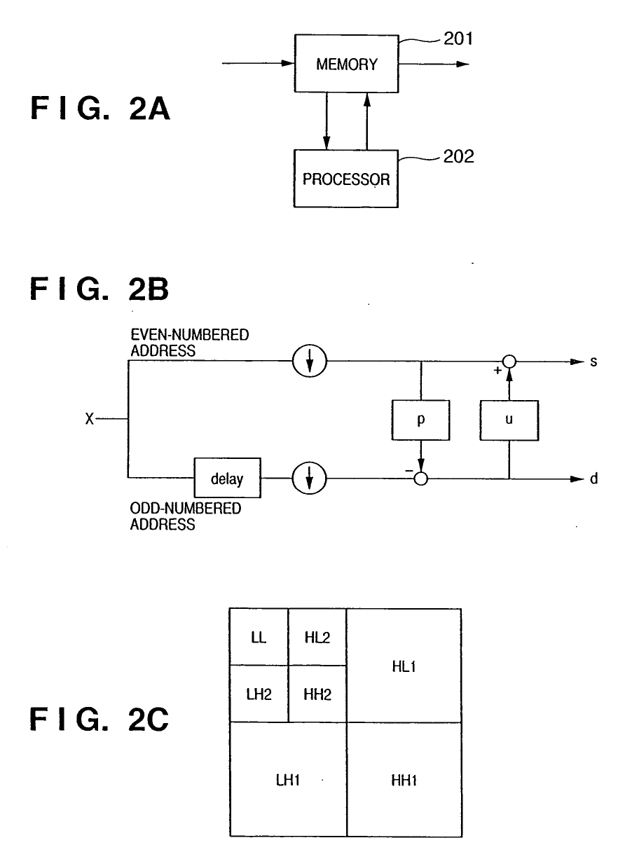

The discrete wavelet transform unit 102 performs two-dimensional discrete wavelet transform processing on the input image signal, calculates transform coefficients and outputs them. FIG. 2A shows the basic construction of the discrete wavelet transform unit 102. The input image signal is stored into a memory 201, and sequentially read out by a processor 202 then subjected to transform processing, and written into the memory 201 again. In the present embodiment, the construction of the processor 202 is as shown in FIG. 2B. In FIG. 2B, the input image signal is separated into even-numbered address and odd-numbered address signals by a combination of delay device and down sampler, and subjected to filter processing by 2 filters p and u. In the figure, alphabets s and d denote low-pass coefficient and high-pass coefficient upon 1-level separation on respectively one-dimensional image signals, and are calculated by the following expressions.
d(n)=x(2n+1)−floor((x(2n)+x(2n+2))/2) (1)
s(n)=x(2n)+floor((d(n−1)+d(n))/4) (2)

Note that x(n) is an image signal to be transformed; further, floor{R}, a maximum integral value not greater than a real number R. By the above processing, one-dimensional discrete wavelet transform processing is performed on the image signal. Two-dimensional discrete wavelet transform is sequentially performing one-dimensional transform on an image in horizontal and vertical directions. As the details of the two-dimensional discrete wavelet transform are well known, the explanations thereof will be omitted here. FIG. 2C shows an example of structure of 2-level transform coefficient group obtained by two-dimensional transform processing. The image signal is divided into coefficient strings HH1, HL1, HL1, . . . , and LL in different frequency bands. Note that in the following description, these coefficient strings will be called subbands. The coefficients of the respective subbands are outputted to the subsequent quantization unit 103.

The quantization unit 103 quantizes the input coefficient by a predetermined quantization step, and outputs an index to the quantized value. The quantization is performed by the following expression.
q=sign(c)floor(abs(c)/Δ) (3)
sign(c)=1; c≧0 (4)
sign(c)=−1; c<0 (5)

Note that c is a quantized coefficient. Further, in the present embodiment, the value of Δ includes “1”. In this case, quantization is not actually performed, and the transform coefficient inputted into the quantization unit 103 is outputted to the digital watermark embedding unit 104.

The digital watermark embedding unit 104 embeds additional information as a digital watermark in the quantized transform coefficient. The embedding of additional information will be described in detail later. The quantized index in which the additional information as the digital watermark is embedded by the digital watermark embedding unit 104 is outputted to the entropy coding unit 105.

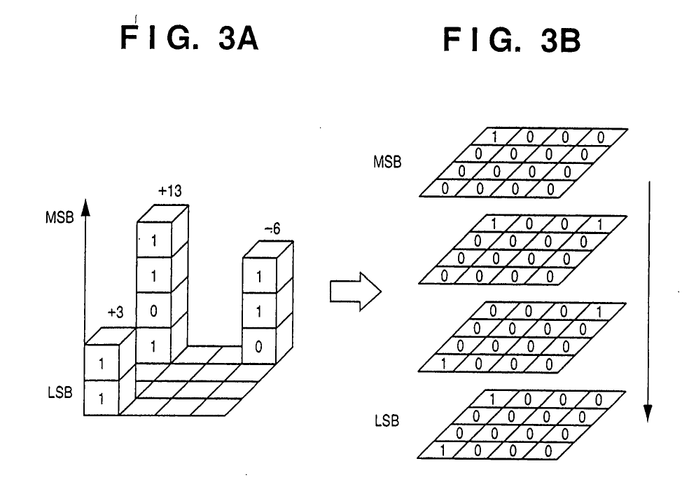

The entropy coding unit 105 divides the input quantized index into bit planes, performs bit plane-based binary arithmetic coding, and outputs a code stream. FIGS. 3A and 3B are explanatory diagrams showing the operation of the entropy coding unit 105. In this example, 3 non-zero quantized indexes, having values +13, −6 and +3, exist in a 4×4 sized subband area. The entropy coding unit 105 scans this area then obtains a maximum value M, and calculates the number of bits S necessary for representation of a maximum quantized index by the following expression.
S=ceil(log 2(abs(M)) (8)

Note that ceil(x) is a minimum integral value among integers equal to or greater than x. As the maximum coefficient value is 13 in FIGS. 3A and 3B, the value of S obtained by the expression (8) is 4. Accordingly, as shown in FIG. 3B, 16 quantized indexes in the sequence are processed by 4 bit planes. First, the entropy coding unit 105 performs entropy coding (binary arithmetic coding in the present embodiment) on respective bits of the most significant bit plane (MSB in the figures), and outputs them as a bit stream. Next, the entropy coding unit processes a 1-level lower bit plane, thus encodes respective bits in bit planes until coding is completed in a least significant bit plane (LSB in the figures) in this manner, and outputs coded bits to the code output unit 106. Note that upon the above-described entropy coding, when a non-zero bit to be encoded first (most significant) is detected in bit plane scanning from the most significant bit plane to the least significant bit plane, the bit is subjected to binary arithmetic coding, with 1 bit indicating positive/negative sign of the quantized index immediately thereafter. By this coding, the positive/negative sign of quantized index except 0 can be efficiently encoded.

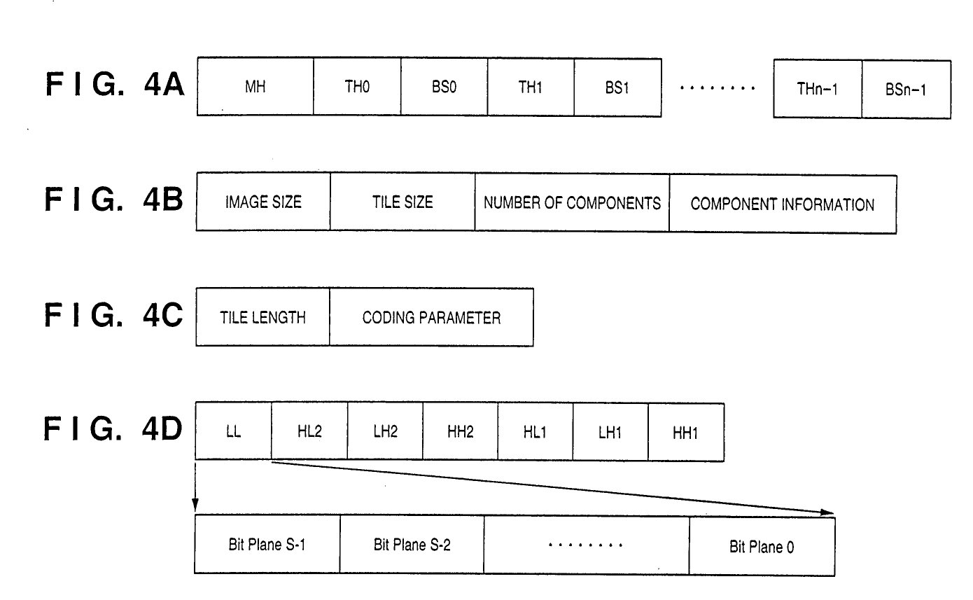

FIGS. 4A to 4D are explanatory diagrams of structures of code strings generated and outputted in this manner. FIG. 4A shows the entire structure of code string. MH denotes a main header; TH, a tile header; and BS, a bit stream. Note that the code stream in the figure shows that an image is divided into n rectangular areas (tiles) and tile headers and bit streams are generated for the respective tiles.

As shown in FIG. 4B, the main header MH comprises the size of image to be encoded (numbers of pixels in horizontal and vertical directions), the size of tiles as plural rectangular areas divided from the image; the number of components representing respective color components; sizes of the respective components; and component information indicating bit precision. Note that in the present embodiment, as the image is not divided into tiles, the tile size and the image size have the same value, and in a case where a monochrome multivalue image is handled, the number of components is 1.

FIG. 4C shows the structure of the tile header TH. The tile header TH comprises a tile length including a bit stream length of the tile and a header length, and a coding parameter for the tile. The coding parameter includes a discrete wavelet transform level, a filter type and the like. FIG. 4D shows the structure of the bit stream of the present embodiment. In FIG. 4D, the bit streams are generated for respective subbands, and sequentially arranged from a low resolution subband in increasing order. Further, in each subband, codes are arrayed in bit plane units from a high order bit plane to a low order bit plane.

In the above-described embodiment, the compression rate of the entire image to be encoded can be controlled by changing the quantization step Δ. Further, in the present embodiment, as another method, lower bits of bit plane to be encoded by the entropy coding unit 105 may be limited (deleted) in accordance with a necessary compression rate. In this case, coding is not performed on all the bit planes but on bit planes corresponding to a desired compression rate from the most significant bit plane, and the coded result is included into a final code string.

The apparatus having the above-described construction obtains a code string in which additional information is embedded as a digital watermark. Hereinbelow, the details of the method for embedding additional information as a digital watermark will be described.

<Principle of Patchwork Method>

In the present embodiment, a principle called patchwork method is employed for embedding the additional information Inf. Accordingly, the principle of the patchwork method will be described first.

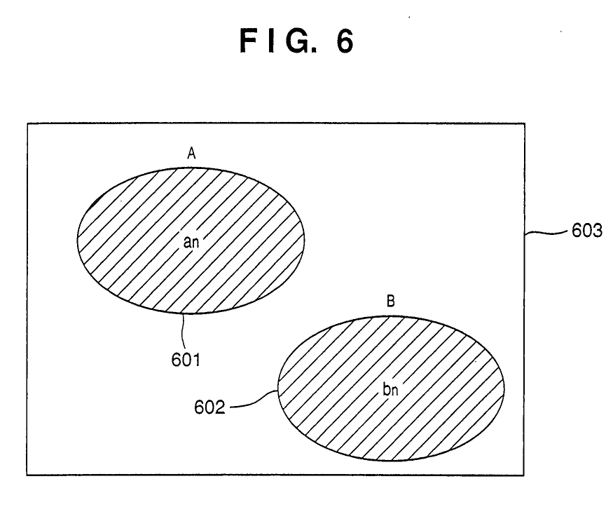

The patchwork method realizes embedding of the additional information Inf by causing a statistical bias in an image. FIG. 6 shows the embedding.

In FIG. 6, numerals 601 and 602 denote subsets of pixels; and 603, the entire image. 2 subsets 601 (subset A) and 602 (subset B) are selected from the entire image 603.

By the selection of 2 subsets, the additional information Inf can be embedded by the patchwork method of the present embodiment unless the subsets overlap with one another. Note that the size and selection of 2 subsets greatly influence the resistance of the additional information Inf embedded by the patchwork method, i.e., the strength of image data wI not to lose the additional information Inf when the image data is attacked, to be described later.

The subsets A and B have N elements and expressed as A={a1, a2, . . . , aN} and B={b1, b2, . . . , bN}. The respective elements ai and bi of the subsets A and B are quantized coefficient values or sets of quantized coefficient values.

Then the following index d is defined.

$$\begin{matrix}d = 1 / N \times \sum ( ai - bi ) \\ = 1 / N \times \{ ( a1 - b1 ) + ( a2 - b2 ) + … + ( aN - bN ) \}\end{matrix} \qquad ( 9 )$$

The expression (9) represents an expected value of difference between the 2 subsets A and B. If appropriate subsets A and B are selected from a general natural image, the above-described index d is defined as
d≅0 (10)
Hereinbelow, the index d will be called a reliability distance. On the other hand, an operation to embed the additional information Inf is
a′i=ai+c (11)
b′i=bi−c (12)
This is adding the value c to all the elements of the subset A and subtracting the value c from all the elements of the subset B.

Also, the subsets A and B are selected from the image in which the additional information Inf is embedded, and the index d is calculated.

$$\begin{matrix}d = 1 / N \sum ( {a}^{′} i - {b}^{′} i ) \\ = 1 / N \sum \{ ( ai + c ) - ( bi - c ) \} \\ = 1 / N \sum ( ai - bi ) + 2 c \\ = 2 c\end{matrix} \qquad ( 13 )$$

The index value is not 0. That is, for some image, the reliability distance d is calculated, and if d≅0 holds, it is determined that the additional information Inf is not embedded, while if d has a value greater than 0 by a predetermined amount, it is determined that the additional information Inf is embedded.

The basic idea of the patchwork method is as described above. Originally, the patchwork method is performed on image luminance values or the like, however, in the present embodiment, a digital watermark is embedded in quantized wavelet transform coefficients by using the patchwork method, since the quantized wavelet transform coefficient has a characteristic of the expression (10) as in the case of image luminance value. The wavelet transform coefficients included in the lowest area (LL) among wavelet transform coefficients has a feature like a reduced image of original image, accordingly, especially the characteristic in the expression (10) noticeably appears. Accordingly, in the present embodiment, the digital watermark is embedded in the wavelet transform coefficients included in the LL subband by the patchwork method.

Note that in the present embodiment, the digital watermark is embedded in the LL subband coefficients, however, the subband is not limited to the LL subband. The digital watermark may be embedded in subbands other than the LL subband. Further, in the present embodiment, the digital watermark is embedded in the quantized wavelet transform coefficients by the patchwork method, however, the transform coefficients are not limited to the quantized wavelet transform coefficients. The digital watermark may be embedded by the patchwork method directly in wavelet transform coefficients which are not quantized.

Further, in the present embodiment, plural additional information Inf are embedded by the patchwork method. In this case, the selection of subsets A and B is defined by a pattern array to be described later.

In the above method, elements of the pattern array to be described later are added or subtracted to/from predetermined elements of LL subband, thereby the additional information Inf can be embedded.

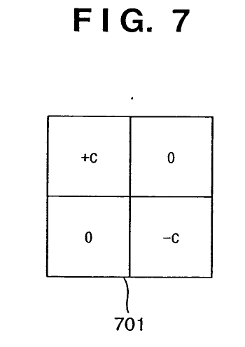

FIG. 7 shows an example of pattern array. The pattern array, which is employed when 1-bit additional information Inf is embedded in 2×2 wavelet transform coefficients, indicates coefficient change amounts from initial coefficients. As shown in FIG. 7, the pattern array has an array element having a positive value, an array element having a negative value, and array elements having a 0 value.

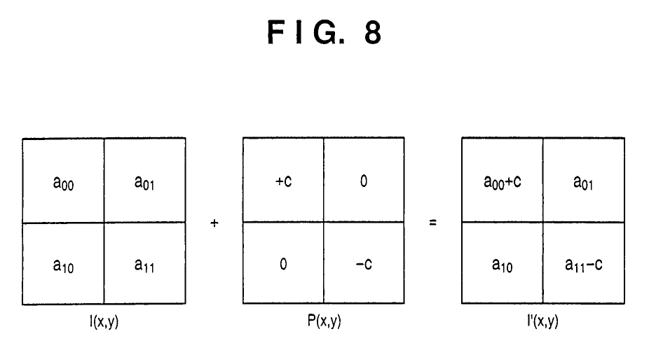

FIG. 8 shows a method for embedding the pattern array in transform coefficients. In FIG. 8, I(x,y) is a 2×2 transform coefficient group with (x,y) as a left upper position; P(x,y), the above-described pattern array; and I′(x,y), a transform coefficient group in which 1-bit additional information Inf is embedded. As shown in FIG. 8, elements of the pattern array P(x,y) are inserted in the respective elements of the transform coefficient group I(x,y) corresponding to the respective positions of the pattern array, thereby the transform coefficient group I′(x,y) in which the 1-bit additional information Inf is embedded is generated.

The above operation is performed plural times without redundancy within the LL subband, thereby the 1-bit additional information Inf can be embedded in the LL subband. As a result, a set of transform coefficients where the values are changed by the +c array element corresponds to the above-described subset A, and a set of transform coefficients where the values are changed by the −c array element corresponds to the above-described subset B. Further, a set of transform coefficients where the values are not changed does not belong to the subset A nor the subset B.

Note that in the following description, since the additional information Inf has plural bits, processing for embedding plural bits must be performed. However, the basic processing is the same as the above-described 1-bit embedding processing. In the present embodiment, when plural bits are embedded, to avoid overlap between areas where the transform coefficient values are changed using a pattern array, relative positions to use the pattern array are determined in advance between corresponding bits. That is, the relation between a position of pattern array to embed the first bit information of the additional information and a position of the pattern array to embed the second bit information is appropriately determined. The details of this position determination will be described later.

In the present embodiment, not to change the entire image density, the number of array elements having a positive value and the number of array elements having a negative value are the same. That is, in 1 pattern array, the sum of all the array elements is 0. Note that upon extraction of additional information Inf to be described later, this condition is necessary.

Note that in the present embodiment, if original image data is large, the additional information Inf is repeatedly embedded. Since the patchwork method utilizes a statistic characteristic, a sufficient number of embedding is required to attain the statistic characteristic.

Further, if image data is large, the additional information Inf (respective bit information forming this information) are repeatedly embedded as many times as possible such that the respective bits of the additional information Inf can be properly extracted. Especially, in the present embodiment, as statistic measurement is performed by utilizing the repeatedly embedded same additional information Inf, the repeated embedding is important.

<Determination of Pattern Array>

In the patchwork method, the determination of subsets A and B greatly influences the resistance of the additional information Inf against attacks and the image quality of image in which the additional information Inf is embedded. Hereinbelow, a method for providing the additional information Inf embedded by the patchwork method with resistance against attacks will be described.

In the patchwork method, the shape of pattern array and the values of elements are parameters to determine a trade-off between the strength of embedded additional information Inf and the image quality of the image data wI. Accordingly, whether or not the additional information Inf can be extracted after attack on the image depends on the parameters. A more detailed description will be made about this point.

Note that in the following description, a set (subset A) of coefficients having a positive value (+c) of pattern array is called a positive patch; a set (subset B) of coefficients having a negative value (−c), a negative patch. In the following description, in a case where a patch is used without positive/negative distinction, the patch is one or both of positive patch and negative patch.

In FIG. 7, if the number of elements of the pattern array increases, as the value of the reliability distance d in the patchwork method increases, the resistance of the additional information Inf increases, and in an image in which the additional information Inf is embedded, the image quality is seriously degraded in comparison with the original image.

On the other hand, if the value of the respective elements of the pattern array in FIG. 7 decreases, the resistance of the additional information Inf is weakened, and the image quality of the image in which the additional information Inf is embedded is not much degraded in comparison with the original image.

In this manner, it is very important for the resistance and the image quality of the image data wI to optimize the size of the pattern array in FIG. 7 and the value of the patch elements (±c) forming the pattern.

First, the patch size (the number of elements) will be considered. If the patch size is increased, the resistance of the additional information Inf embedded by the patchwork method increases. On the other hand, if the patch size is reduced, the additional information Inf embedded by the patchwork method is weakened. If the patch size is increased, a signal modulated for embedding the additional information Inf is embedded as a low-frequency component signal, on the other hand, if the patch size is reduced, the signal modulated for embedding the additional information Inf is embedded as a high-frequency component signal.

If the image comes under attack, there is a possibility that the additional information Inf embedded as a high-frequency component signal is deleted, on the other hand, the additional information Inf embedded as a low-frequency component signal is not deleted and is extracted.

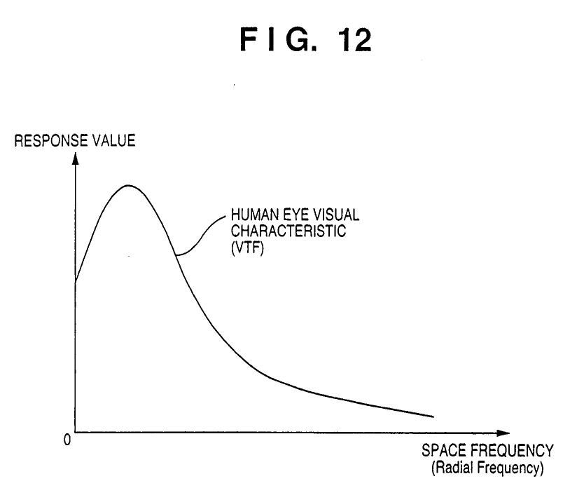

Accordingly, it is desirable that the patch size is large to provide the additional information Inf with sufficient resistance against attacks. However, the increase in patch size equals addition of low-frequency component signal to the original image, which leads to further degradation of image quality in the image data wI, since human visual characteristic has a VTF characteristic as shown in FIG. 12. As it is understood from FIG. 12, the human visual characteristic is comparatively sensitive to low-frequency noise but comparatively insensitive to high-frequency noise. Accordingly, it is desirable to optimize the patch size to determine the strength of the additional information Inf embedded by the patchwork method and the image quality in the image data wI.

Next, the patch value (±c) will be considered. The value of respective elements (±c) constructing the patch is called a “depth”. If the patch depth is increased, the resistance of the additional information Inf embedded by the patchwork method increases, on the other hand, if the patch depth is reduced, the additional information Inf embedded by the patchwork method is weakened.

The patch depth closely relates to the reliability distance d employed for extraction of additional information Inf. The reliability distance d is a calculation value for extracting the additional information Inf and the value will be described in more detail in extraction processing. Generally, if the patch depth is increased, the reliability distance d is increased and the additional information Inf is easily extracted. On the other hand, if the patch depth is reduced, the reliability distance d is reduced, and the additional information Inf cannot be easily extracted.

Accordingly, as the patch depth is also a significant parameter to determine the strength of the additional information Inf and the image quality of image in which the additional information Inf is embedded, it is desirable to optimize the patch depth. If a patch having optimized patch size and depth is always used, the additional information can be embedded with resistance against various attacks and degradation of image quality can be suppressed.

Note that in the present embodiment, the additional information Inf by using pattern array is embedded in quantized LL subband coefficients. The appearance of the pattern array embedded in the quantized subband coefficients in a decoded image will be described later.

<Digital Watermark Embedding Unit>

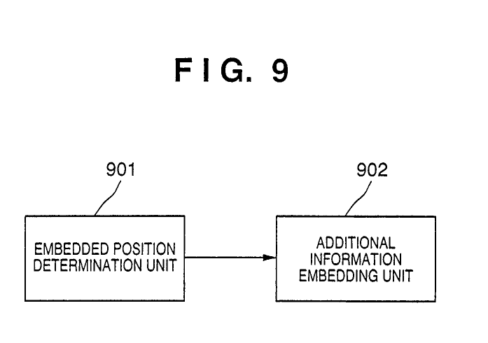

As described above, in the present embodiment, the additional information is embedded by using the patchwork method in coefficients included in the LL subband among wavelet transform coefficients. Hereinbelow, a particular digital watermark embedding unit in the present embodiment will be described with reference to FIG. 9. The digital watermark embedding unit has an embedded position determination unit 901 and an additional information embedding unit 902. In the following description, the respective units will be described in detail.

<Embedded Position Determination Unit>

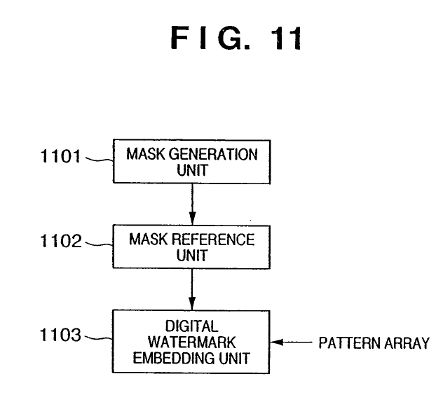

First, the embedded position determination unit 901 of the present embodiment will be described with reference to FIG. 11 showing the construction thereof. The embedded position determination unit 901 has mask generation unit 1101, a mask reference unit 1102 and a digital watermark embedding unit 1103.

When respective bit information of the additional information Inf are embedded in the transform coefficients, the mask generation unit 1101 generates a mask to define embedded positions. The mask means a matrix having positional information to define relative arrangement of pattern array (See FIG. 7) corresponding to the respective bit information.

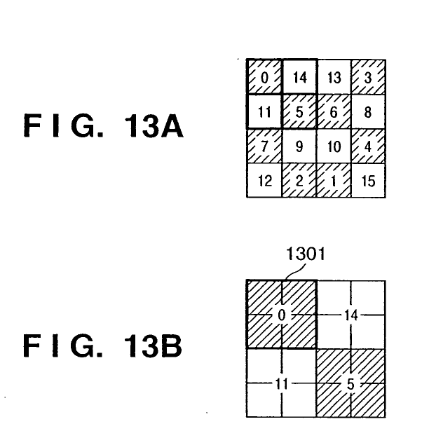

FIGS. 13A and 13B shows examples of the mask. The mask in FIG. 13A is used to handle maximum 16-bit additional information Inf. Numerals described inside the mask are indexes of ordinal positions of bits of the additional information Inf to be embedded. The details of the mask will be described later.

Next, the mask reference unit 1102 reads the mask generated by the mask generation unit 1101, and determines arrangement of pattern array to embed the respective bit information with linkages between the respective numerals in the mask and the information indicating the ordinal positions of the respective bit information.

Further, the digital watermark embedding unit 1103 arranges the respective array elements of the pattern array (of e.g. 2×2 size) in the positions of the numerals in the mask. FIG. 13B shows the arranged pattern array elements in a bold block in FIG. 13A. In FIG. 13B, e.g., a portion where the pattern array is arranged to embed the first bit of the additional information Inf (the bold block 1301 in FIG. 13B) is divided by a dotted line into 4 spaces respectively corresponding to the transform coefficients. Accordingly, the first bit of the additional information Inf is embedded in the transform coefficients positionally corresponding to these spaces.

Note in the present embodiment, the mask generation unit 1101 generates the above-described mask every time data of transform coefficients is inputted. Accordingly, if large sized image data is inputted, the same additional information Inf is repeatedly embedded plural times.

When the additional information Inf is extracted from the image, the arrangement of the above-described mask (array of coefficients) functions as a key. That is, only a key holder can extract the information.

Note that it may be arranged such that the above-described mask is not generated in a realtime manner but a previously-generated mask is stored in an internal memory of the mask generation unit 1101 or the like and the stored mask is read as required. In this case, the subsequent processing can be quickly performed. In any way, the used mask is added to the code string outputted from the coding apparatus for an apparatus to extract the digital watermark. However, the invention is not limited to this arrangement. If the previously-generated mask is stored in the internal storage of the mask generation unit 1101 or the like, a digital watermark extraction device (decoding apparatus to be described later) may refer to the storage, or the mask may be registered in the decoding apparatus in advance.

Further, in the present embodiment, actually, the additional information is embedded in the entire LL subband. For this purpose, the mask in FIGS. 13A and 13B having the same size as that of the LL subband must be prepared. Otherwise, the additional information can be embedded in the entire LL subband by repeatedly using the mask in FIGS. 13A and 13B in the LL subband.

<Additional Information Embedding Unit>

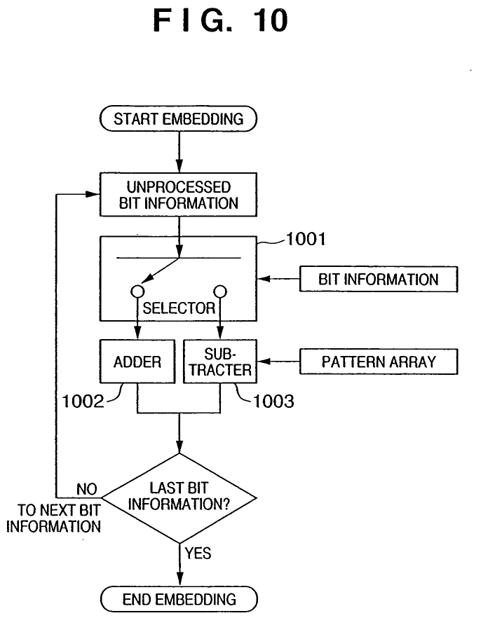

Next, the additional information embedding unit of the present embodiment will be described with reference to FIG. 10. FIG. 10 shows the flow of processing to repeatedly embed the additional information Inf. In FIG. 10, first, the first bit information of the additional information Inf is repeatedly embedded, then the second bit information is similarly embedded, then the third bit information is similarly embedded, thus, the respective bit information are repeatedly embedded.

More particularly, in the additional information Inf, if bit information to be embedded is “1”, the pattern array in FIG. 7 is added to the transform coefficients. Further, if bit information to be embedded is “0”, the pattern array in FIG. 7 is subtracted, i.e., the pattern array with a sign inverted from that in FIG. 7 is added to the transform coefficients.

The above addition/subtraction processing is realized by controlling the selector 1001 in FIG. 10 in accordance with bit information to be embedded. That is, if the bit information to be embedded is “1”, the selector 1001 is connected to an adder 1002, while if the bit information is “0”, the selector 1001 is connected to a subtracter 1003. The processing by the selector 1001, the adder 1002 and the subtracter 1003 is performed while the bit information and pattern array information are referred to.

FIG. 8 shows the embedding of one of the above bit information. In FIG. 8, the embedded bit information is “1”, i.e., the pattern array is added to the transform coefficients.

In FIG. 8, I(x,y) has initial subband coefficients, and P(x,y) is a 2×2 pattern array. The respective coefficients constructing the 2×2 pattern array are overlaid on the coefficients of LL subband having the same size of the pattern array, and addition/subtraction is performed between values of the same position. As a result, I′(x,y) is calculated as LL subband coefficient data in which the bit information is embedded.

The above addition/subtraction processing using 2×2 pattern array is repeatedly performed on all the embedded positions determined by the digital watermark embedding unit 1103. For example, to embed the first bit information, the above addition/subtraction processing is performed on the all the LL subband coefficients corresponding to “0” coefficient of the mask coefficients.

By the above-described method, a code string in which the digital watermark is embedded can be generated. Note that information specifying the subband (LL subband in the present embodiment) where the digital watermark embedding has been made is added to the code string outputted from the coding apparatus, however, the invention is not limited to this arrangement, but it may be arranged such that a subband in which a digital watermark is embedded is determined in advance and is registered in a decoding apparatus to be described later.

<Decoding Apparatus>

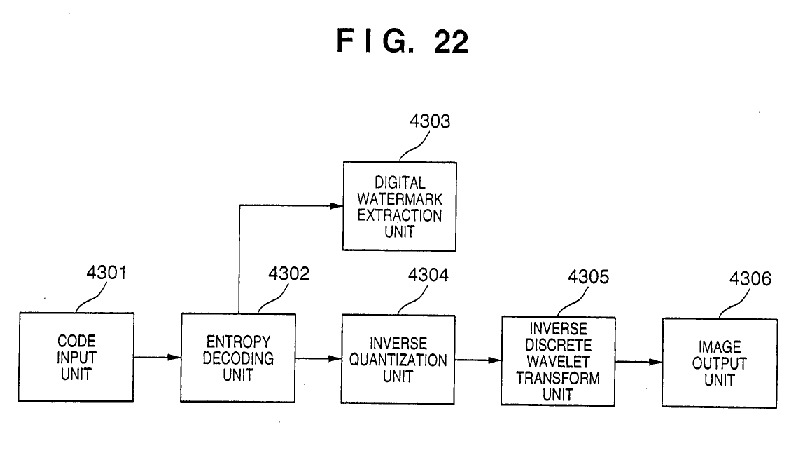

Next, the decoding apparatus and its method for decoding the bit stream by the coding apparatus as described above will be described. FIG. 22 is a block diagram showing the construction of the decoding apparatus according to the present embodiment. Numeral 4301 denotes a code input unit; 4302, an entropy decoding unit; 4303, a digital watermark extraction unit; 4304, an inverse quantization unit; 4305, an inverse discrete wavelet transform unit; and 4306, an image output unit.

The code input unit 4301 inputs a code string, detects a header included in the code string extracts parameters necessary for the subsequent processing, and if necessary, controls the flow of processing, or transmits a corresponding parameter to the subsequent processing unit. Further, the bit stream included in the code string is outputted to the entropy decoding unit 4302.

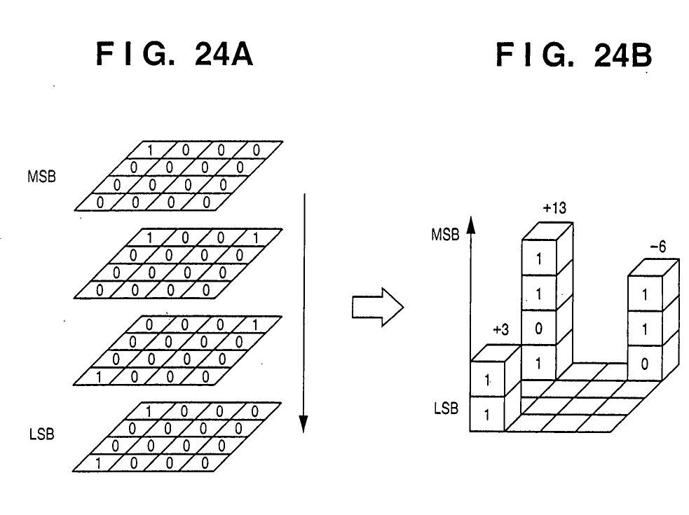

The entropy decoding unit 4302 decodes the bit stream in bit plane units and outputs the decoded bit stream. FIGS. 24A and 24B show the decoding procedure at this time. FIG. 24A shows the flow of processing to sequentially decoding an area of subband to be decoded in bit plane units, and finally decode a quantization index. The bit planes are decoded in the order indicated by an arrow in the figure. The decoded quantization index is outputted to the digital watermark extraction unit 4303 and the inverse quantization unit 4304.

The digital watermark extraction unit 4303 extracts a digital watermark from the decoded quantization index. The details of the digital watermark extraction unit will be described later.

The inverse quantization unit 4304 decodes a discrete wavelet transform coefficient from the input quantized index.
c′=Δ×q; q≠0 (14)
c′=0; q=0 (15)

Note that q denotes a quantization index; Δ, a quantization step having the same value Δ as that used upon coding; c′, a decoded transform coefficient decoded from a coefficient s or d in coding. The transform coefficient c′ is outputted to the subsequent inverse discrete wavelet transform unit 4305.

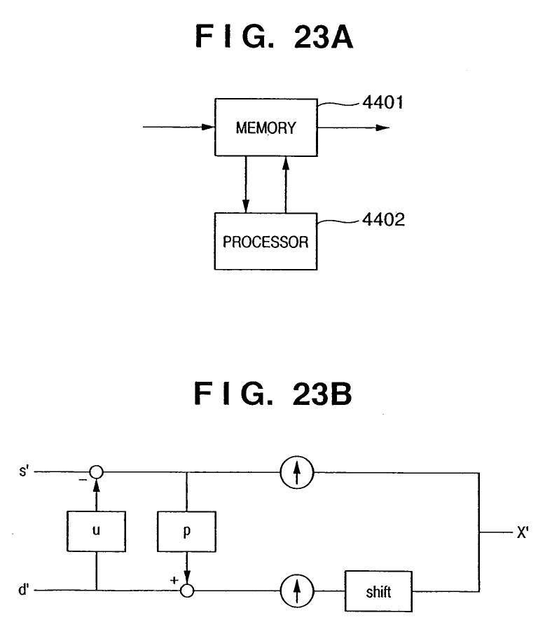

FIGS. 23A and 23B are block-diagrams showing the construction and processing by the inverse discrete wavelet transform unit 4305. In FIG. 23A, the input transform coefficient is stored into a memory 4401. A processor 4402 performs one-dimensional inverse discrete wavelet transform, and sequentially reads the transform coefficient from the memory 4401 and processes it, thereby performing two-dimensional inverse discrete wavelet transform. The two-dimensional inverse discrete wavelet transform is executed. The two-dimensional inverse discrete wavelet transform is performed in reverse order to forward transform, however, as the details of the transform are well known, the explanations thereof will be omitted. Further, FIG. 23B shows processing blocks of the processor 4401. The input transform coefficient is subjected to processing by 2 filters u and p, then subjected to up sampling and overlaid one another, and an image signal x′ is outputted. These processings are performed by the following expression.
x′(2n)=s′(n)−floor((d′(n−1)+d′(n))/4) (16)
x′(2n+1)=d′(n)+floor((x′(2n)+x′(2n+2))/2) (17)

Note that the forward and inverse discrete wavelet transform by the expressions (1), (2), (16) and (17) satisfy a complete reconstruction condition. Accordingly, assuming that the quantization step Δ is 1, if all the bit planes are decoded in bit plane decoding, the decoded image signal x′ corresponds with the original image signal x.

The image is decoded by the above processing and outputted to an image output unit 4306. The image output unit 4306 may be an image display device such as a monitor or may be a storage device such as a magnetic disc.

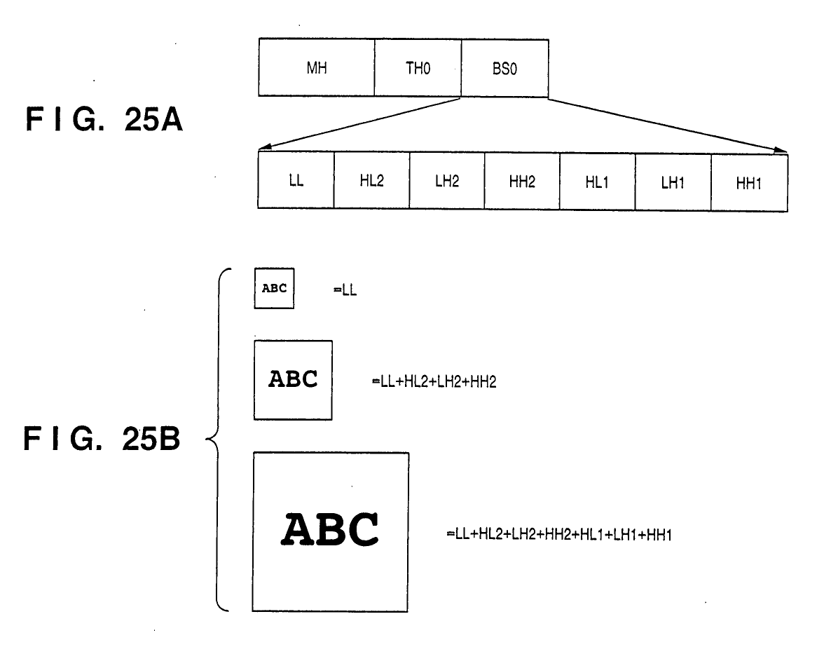

The image display format upon display of image decoded by the above-described procedure will be described with reference to FIGS. 25A and 25B. FIG. 25A shows an example of code string. The basic structure is based on the code string in FIG. 4, however, in this structure, the entire image is a tile. Accordingly, the code string includes only one tile header and bit stream. As shown in FIG. 25A, in a bit stream BS0, codes are arranged from LL corresponding to the lowest resolution in increasing order.

The decoding apparatus sequentially reads the bit stream, and when codes corresponding to the respective subbands have been decoded, displays an image. FIG. 25B shows the correspondence between the respective subbands and the size of displayed image. In this example, 2-level two-dimensional discrete wavelet transform is performed. If only the LL subband is decoded and displayed, an image where the number of pixels is reduced to ¼ of that of the original image in horizontal and vertical directions is reproduced. If bit streams are further read and all the level-2 subbands have been decoded and displayed, an image where the number of pixels is reduced to ½ in the respective directions is reproduced. Further, if all the level-1 subbands have been decoded, an image having the same number of pixels as that of the original image is reproduced.

In the above-described embodiment, the amount of received or processed coded data can be reduced by limiting (ignoring) a lower order bit plane to be decoded by the entropy decoding unit 4302, and as a result, the compression rate can be controlled. In this manner, a decoded image of a desired image quality can be obtained from coded data having a necessary amount of data. Further, if the quantization step Δ upon coding is 1 and all the bit planes have been decoded, reversible coding and decoding in which a reproduced image corresponds with the original image can be realized.

<Digital Watermark Extraction Unit>

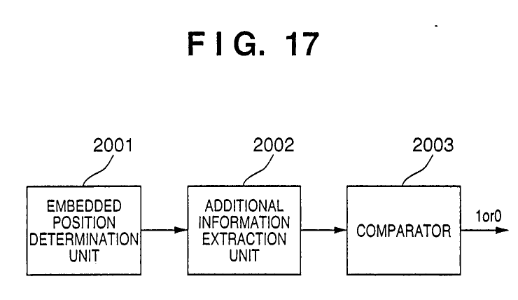

Next, the details of the operation of the digital watermark extraction unit 4303 will be described. FIG. 17 shows the flow of digital watermark extraction. As shown in FIG. 17, the digital watermark extraction unit has an embedded position determination unit 2001, an additional information extraction unit 2002 and a comparator 2003. Hereinbelow, the detailed operations will be described.

<Embedded Position Determination Unit>

First, the embedded position determination unit 2001 will be described. The embedded position determination unit 2001 determines an area in the LL subband from which the additional information Inf is to be extracted. Note that the subband from which the additional information Inf is to be extracted (LL subband here) can be specified by reading the above-described information (information specifying the subband in which the digital watermark is embedded) added to the code string outputted from the coding apparatus.

As the operation of the embedded position determination unit 2001 is the same as that of the above-described embedded position determination unit 901, the area determined by the embedded position determination unit 2001 is the same as that determined by the embedded position determination unit 901.

The additional information Inf is extracted from the determined area by using the pattern array in FIG. 7. Note that hereinafter, a description will be made about a case where a 2×2 pattern array is inputted into the embedded position determination unit 2001 in FIG. 17, however, the embedded position determination unit performs a similar operation in use of other pattern arrays.

<Additional Information Extraction Unit>

The reliability distance d is a calculated value necessary for extracting the embedded information.

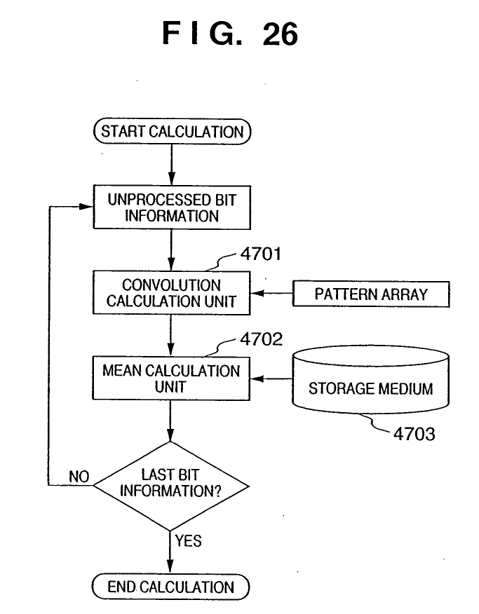

FIG. 26 shows a method for obtaining a reliability distance d corresponding to each bit information.

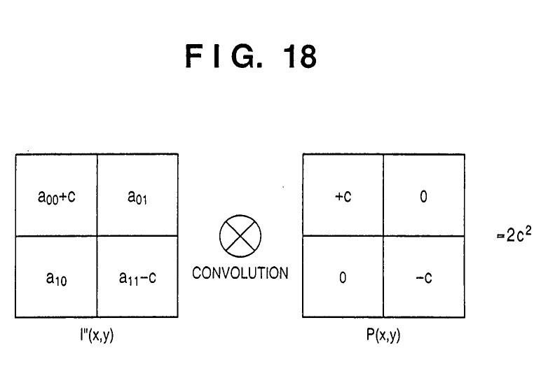

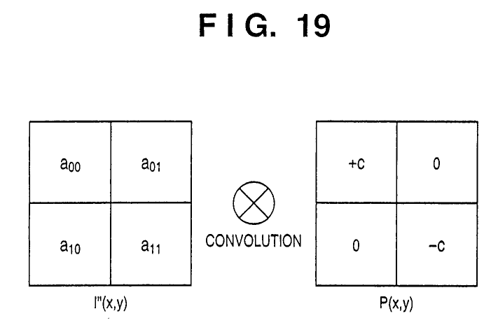

First, processing by a convolution calculation unit 4701 in FIG. 26 will be described with reference to FIGS. 18 and 19.

FIGS. 18 and 19 show an example where 1-bit information constructing the additional information Inf is extracted.

FIG. 18 shows an example where 1-bit information extraction processing is performed on an LL subband coefficient I″(x,y) in which 1-bit information is embedded. FIG. 19 shows an example where the 1-bit extraction processing is performed on an LL subband coefficient I″(x,y) in which 1-bit information is not embedded.

In FIG. 18, I″(x,y) is an LL subband coefficient in which 1-bit information is embedded, P(x,y), a 2×2 pattern array (pattern array for extraction of additional information Inf) employed for convolution. The respective elements (0,±c) constructing the 2×2 pattern array are integrated to coefficient value arranged in the same position of the input subband coefficient I″(x,y), and further, the sum of the respective integrated values is calculated. That is, P(x,y) is convoluted with respect to I″(x,y). Note that I″(x,y) is expression including coefficient data when the LL subband coefficient I′(x,y) comes under attack. If it is not attacked, I″(x,y)=I′(x,y) holds. If 1-bit information is embedded in I″(x,y), there is high probability that a non-zero value is obtained as a result of the above-described convolution as shown in FIG. 18. Especially when I″(x,y)=I′(x,y) holds, the result of convolution is 2c².

Note that in the present embodiment, the pattern array employed for embedding is the same as the pattern array employed for extraction. The pattern array may be inputted into the decoding apparatus as a key for extraction of digital watermark, or may be shared by the coding apparatus and the decoding apparatus in advance. Further, the pattern array (or information specifying the pattern array) may be added to the code string outputted from the coding apparatus. In any case, the decoding apparatus generates the same pattern array as that in FIG. 7 used in the coding apparatus. However, the pattern array is not limited to this pattern array. Generally, assuming that a pattern array used in embedding is P(x,y) and that used in extraction is P′(x,y), the relation between these pattern arrays is deformed as
P′(x,y)=aP(x,y).
Note that a is an arbitrary real number. In the present embodiment, for the sake of simplicity, a=1 holds.

On the other hand, in the example shown in FIG. 19, similar calculation to the above-described calculation is performed on the LL subband coefficient I″(x,y) in which the 1-bit information is not embedded. As a result of the convolution calculation on the LL subband coefficient in which the digital watermark is not embedded, the value 0 is obtained as shown in FIG. 19.

The calculation utilizes the characteristic of the LL subband coefficient. If the convolution in FIG. 19 is calculated as follows.
C*a00−c*a11=c*(a00-a11)

Note that the LL subband coefficients a00 and all are often equal values (or values very close to each other). Accordingly, the result of convolution calculation in FIG. 19 is 0 (or a value close to 0).

The 1-bit information extraction method is as described above with reference to FIGS. 18 and 19. The above description is made about a case where 0 is obtained as the result of convolution calculation on the LL subband coefficient in which the additional information Inf is embedded, which is a very ideal case. On the other hand, in an actual image data area corresponding to a 2×2 pattern array, the result of convolution calculation is seldom 0.

That is, different from the ideal case, in an LL subband coefficient area corresponding to a 2×2 pattern array, if convolution calculation is performed by using the pattern array in FIG. 7 (referring to a mask as arrangement information), a non-zero value may be obtained. Conversely, in an area corresponding to a 2×2 pattern array in an image (image data wI) in which the additional information Inf is embedded, the result of convolution calculation may not be “2c²” but “0”.

However, generally, the respective bit information constructing the additional information Inf are embedded in the original LL subband plural times. That is, the pattern array is embedded in the LL subband plural times.

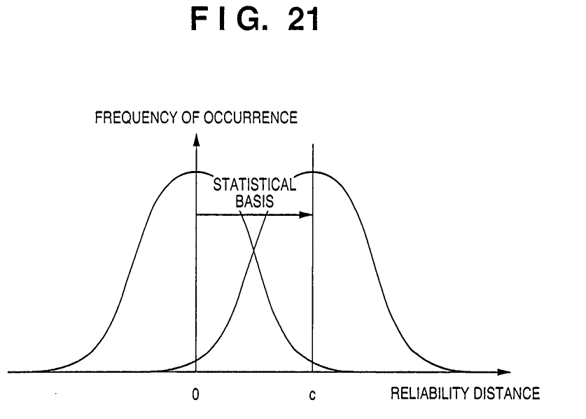

Accordingly, the convolution calculation unit 4701 obtains the sum of the results of plural convolution calculations regarding the respective bit information constructing the additional information Inf. For example, if the additional information Inf has 8 bit information, 8 sums are obtained. These sums corresponding to the respective bit information are inputted into a mean calculation unit 4702, and a mean value is obtained by dividing the information by the number n of repetition of the pattern array corresponding to the respective bit information in the entire macro block. The mean value is the reliability distance d. That is, the reliability distance d is a value similar to “2c²” or “0” in FIG. 21, generated based on majority rule.

Note that as the reliability distance d is defined as d=1/N Σ(ai−bi) in the description of the patchwork method, the reliability distance d strictly is a mean value of results of convolution calculation using P′(x,y)=1/c P(x,y). However, even if convolution calculation is performed by using P′(x,y)=aP(x,y), the mean value of results of convolution calculation is a real-number multiple of the above-described reliability distance d, and substantially the same advantage can be obtained. Accordingly, the mean value of the results of convolution calculation using P′(x,y)=aP(x,y) can also be used as the reliability distance d.

The obtained reliability distance d is stored into a storage medium 4703 such as a hard disk or a CD-ROM.

The convolution calculation unit 4701 repeatedly generates the reliability distance d for the respective bits constructing the additional information Inf and sequentially stores them into the storage medium 4703.

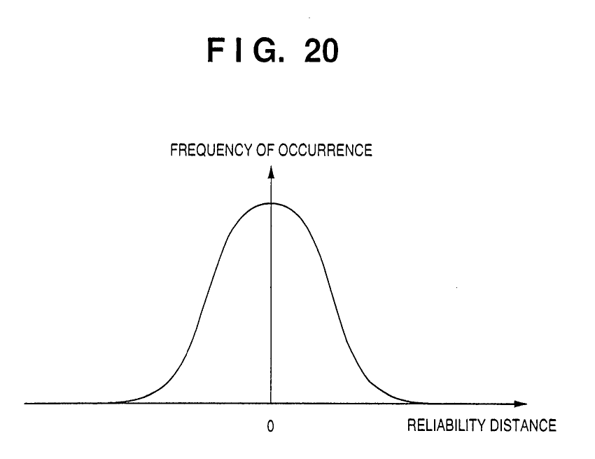

The calculation value will be described in more detail. The reliability distance d calculated by the pattern array in FIG. 7 (mask is also referred to as arrangement information) from the original subband coefficient I is ideally 0. However, in actual image data I, this value is often very close to 0 but a non-zero. FIG. 20 is a graph showing the distribution of frequency of the reliability distance d occurred for the respective bit information.

In FIG. 20, a horizontal axis represents the value of the reliability distance d occurred for the respective bit information, and a vertical axis, the number of bit information where convolution has been performed to cause the reliability distance d (frequency of occurrence of reliability distance d). It is understood from the graph that the distribution is similar to a normal distribution. Further, in the original LL subband coefficient I, the reliability distance d is not always 0, but the mean value is 0 (or a value very close to 0).

On the other hand, in a case where the above-described convolution is performed on, not the original subband coefficient I but the LL subband coefficient I′(x,y) in which the bit information “1” has been embedded as shown in FIG. 8, the distribution of frequency of the reliability distance d is as shown in FIG. 21. That is, the distribution in FIG. 20 is shifted rightward. In this manner, in the LL subband coefficient, in which the 1 bit of the additional information Inf has been embedded, constructing the additional information Inf, the reliability distance d is not always c, but the mean value is c (or a value very close to c).

Note that in FIG. 21, the bit information “1” is embedded, however, if bit information “0” is embedded, the distribution in FIG. 20 is shifted leftward.

As described above, in a case where the additional information Inf (respective bit information) is embedded by using the patchwork method, an accurate statistical distribution as shown in FIGS. 20 and 21 can be obtained as the number of bits to be embedded (the number of use of pattern array) is increased as much as possible. That is, it can be detected with higher precision whether or not bit information of the additional information Inf is embedded or whether the embedded bit information is “1” or “0”.

[Comparator]

The comparator 2003 in FIG. 17 inputs the reliability distance d outputted through the additional information extraction unit 2002. The comparator 2003 merely determines whether each bit information corresponding to the reliability distance d is “1” or “0”.

More particularly, if the reliability distance d of some bit information constructing the additional information Inf is positive, it is determined that the bit information is “1”, while if the reliability distance d is negative, it is determined that the bit information is “0”. The additional information Inf obtained from the above-described determination is outputted as final data.

[Pattern Array in Decoded Image]

Finally, a description will be made about the appearance of digital watermark, embedded by the coding apparatus, in decoded image data obtained by using the decoding apparatus.

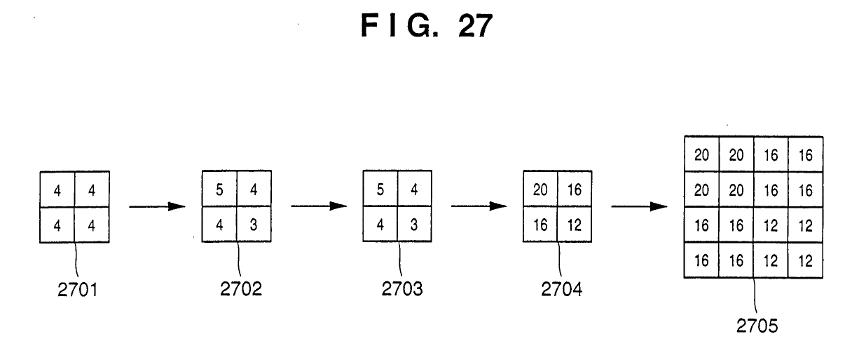

The pattern array embedded in the LL subband coefficients after quantization in the coding apparatus is entropy encoded and stored in the code string. To decode image data from the obtained code string, first, entropy decoding is performed, then inverse quantization is performed, and inverse discrete wavelet transform is performed. That is, the pattern array embedded in the quantized LL subband coefficients by the coding apparatus is subjected to inverse quantization and inverse wavelet transform. Image data in which the digital watermark has been embedded in the quantized LL subband coefficients will be described with reference to FIG. 27.

In FIG. 27, numeral 2701 denotes a part of LL subband coefficients quantized in a case where Δ=4 holds. If the c=1 pattern array in FIG. 7 is added so as to embed additional information “1” in the LL subband coefficients, quantized index data 2702 is obtained. The quantized index data is entropy-encoded, and then entropy-decoded, to data 2703. As entropy coding is irreversible coding, if a code string with embedded additional information is not attacked, the same data is obtained from data 2702 and 2703. The entropy-decoded quantized index is inverse-quantized. Numeral 2704 denotes the data inverse-quantized in the case where Δ=4 holds as in the case of coding. The inverse-quantized data is subjected to inverse wavelet transform. Numeral 2705 denotes an example of the inverse wavelet transform using a 2-tap Haar basis. Thereafter, actually, data other than the LL subband is added to the data 2705, and decoded image data is obtained.

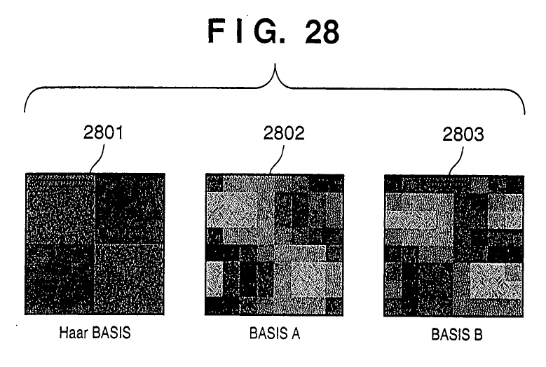

As described above with reference to FIG. 27, the pattern array embedded by the coding apparatus appears as a form of basis of discrete wavelet transform in the image data. FIG. 27 shows the Haar. basis, however, other various basis are applicable to discrete wavelet transform. In FIG. 28, numeral 2801 denotes an example using a Haar basis; 2802, an example using a basis A; and 2803, an example using a basis B. The appearance of pattern array in decoded image can be changed by changing the basis. It is generally known that, in FIG. 27, the basis A is more unrecognizable to human eye than the Haar basis, and further, the basis B is more unrecognizable than the basis A.

### Second Embodiment

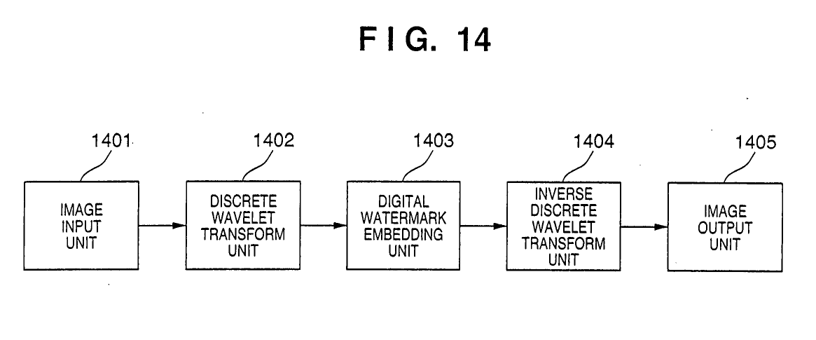

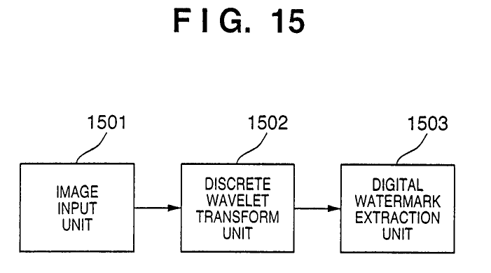

In the first embodiment, the method for embedding a digital watermark by using the patchwork method in compression coding and the method for extracting the digital watermark by using the patchwork method in decoding have been described. On the other hand, the nature of the present invention is embedding a digital watermark in wavelet-transformed coefficients by using the patchwork method. Accordingly, the present invention is not limited to embedding and extraction of digital watermark in compression coding and decoding as described in the first embodiment, and another case of embedding and extraction of digital watermark will be described with reference to FIGS. 14 and 15.

FIG. 14 is a block diagram showing the schematic construction of digital watermark embedding device according to the present embodiment. In FIG. 14, numeral 1401 denotes an image input unit; 1402, a discrete wavelet transform unit; 1403, a digital watermark embedding unit; 1404, an inverse discrete wavelet transform unit; and 1405, an image output unit.

The image input unit 1401 operates similarly to the image input unit 101; the discrete wavelet transform unit 1402, to the discrete wavelet transform unit 102; the digital watermark embedding unit 1403, to the digital watermark embedding unit 104; the inverse discrete wavelet transform unit 1404, to the inverse discrete wavelet transform unit 4305; and the image output unit 1405, to the image output unit 4306.

Next, the digital watermark extraction device of the present embodiment will be described with reference to FIG. 15. In FIG. 15, numeral 1501 denotes an image input unit; 1502, a discrete wavelet transform unit; and 1503, a digital watermark extraction unit.

The image input unit 1501 operates similarly to the image input unit 101; the discrete wavelet transform unit 1502, to the discrete wavelet transform unit 102; and the digital watermark extraction unit 1503, to the digital watermark extraction unit 4303.

That is, the processing performed by the compression coding apparatus and the processing performed by the decoding apparatus are integrated as shown in FIG. 14, thereby embedding and extraction of digital watermark can be performed by a single apparatus irrespective of compression coding and decoding.

Further, in the present embodiment, the appearance of digital watermark in an image can be controlled without changing a pattern array used by the digital watermark embedding unit 1403 by adaptively selecting a basis used by the discrete wavelet transform unit 1402 and that used by the inverse wavelet transform unit 1404. For example, in FIG. 28, visually-sensible degradation of image quality can be reduced by using the basis B in place of the Haar basis.

### Third Embodiment

Further, a method for performing digital watermark embedding in the second embodiment at a high speed will be described.

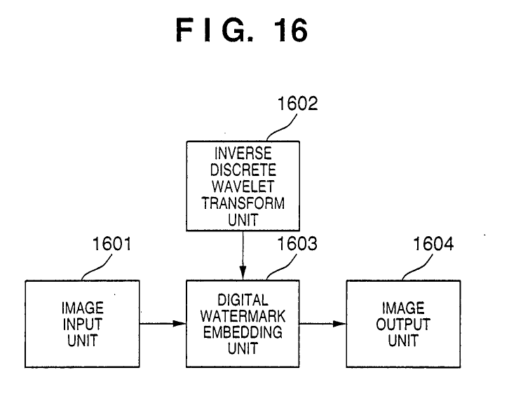

FIG. 16 is a block diagram showing the construction of the digital watermark embedding device according to the present embodiment. In FIG. 16, numeral 1601 denotes an image input unit; 1602, a discrete wavelet transform unit; 1603, a digital watermark embedding unit; and 1605, an image output unit.

First, a pixel signal constructing an image in which a digital watermark is to be embedded is inputted into the image input unit 1601 in raster-scan order, and an output is inputted into the digital watermark embedding unit 1603. The processing performed by the image input unit 1601 is the same as that by the image input unit 101 in FIG. 1, therefore, the explanation of the image input unit will be omitted.

Next, the function of the inverse discrete wavelet transform unit 1602 will be described. The inverse discrete wavelet transform unit 1602 inputs a pattern array, and performs inverse wavelet transform on the input pattern array.

Note that the inverse discrete wavelet transform unit 1602 inputs, e.g., the pattern array 701 in FIG. 7. FIG. 28 shows an array obtained by performing inverse discrete wavelet transform on the pattern array 701, assuming that the input pattern array 701 have wavelet transform coefficients included in the LL subband. In FIG. 28, numeral 2801 is an example using the Haar basis upon inverse discrete wavelet transform; 2802, an example using the basis A; and 2803, an example using the basis B. The pattern array resulted from the inverse wavelet transform is outputted and inputted into the digital watermark embedding unit 1603.

Next, the function of the digital watermark embedding unit 1603 will be described. The digital watermark embedding unit 1603 inputs image data and the pattern array obtained by inverse discrete wavelet, embeds a digital watermark in the input image data by using the pattern array, and outputs the image data in which the digital watermark is embedded. The digital watermark embedding processing performed by the digital watermark embedding unit 1603 is the same as the processing by the digital watermark embedding unit 104 in FIG. 1, therefore, the explanation of the processing will be omitted. The image data in which the digital watermark is embedded is outputted through the image output unit 1604.

As described above, in a case where the digital watermark is embedded irrespective of compression coding, the image is not necessarily discrete wavelet transformed, but the pattern array is inverse discrete wavelet transformed and added to the image data in space area.

Generally, discrete wavelet transform is processing which takes comparatively much time. For this reason, it is more advantageous to perform inverse discrete wavelet transform on a pattern array having a small data amount than perform discrete wavelet transform and inverse discrete wavelet transform on image data or the like having a large data amount since time required for the processing on the pattern array is shorter than that required for the processing on the image data or the like. Accordingly, the construction as shown in FIG. 16 can complete digital watermark embedding at a higher speed in comparison with the digital watermark embedding in the second embodiment.

### Fourth Embodiment

In the first and second embodiments, the digital watermark in the LL subband is extracted by using the pattern array shown in FIG. 7. However, the present invention is not limited to this processing, but the digital watermark extraction can be performed by using an array obtained by inverse discrete wavelet transform on the pattern array in FIG. 7, i.e., the array as shown in FIG. 28. In the present embodiment, a description will be made about a method for extracting the digital watermark by using the pattern array in FIG. 28 resulted from inverse discrete-wavelet transform.

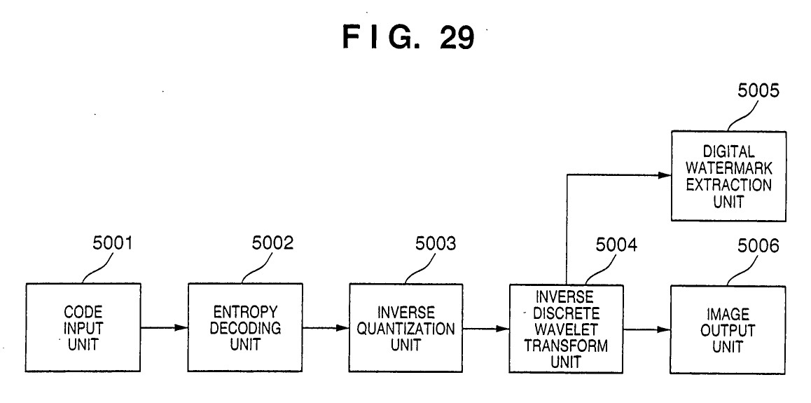

First, the decoding apparatus which extracts the digital watermark from the code string generated by the apparatus having the construction in FIG. 1 and decodes the image data will be described with reference to FIG. 29. In FIG. 29, numeral 5001 denotes a code input unit; 5002, an entropy decoding unit; 5003, an inverse quantization unit; 5004, an inverse discrete wavelet transform unit; 5005, a digital watermark extraction unit; and 5006, an image output unit.

The difference between FIG. 22 and FIG. 29 is that data is inputted from the entropy decoding unit 4302 into the digital watermark extraction unit in FIG. 22, whereas data is inputted from the inverse discrete wavelet transform unit 5004 into the digital watermark extraction unit in FIG. 29. That is, in FIG. 22, frequency-area LL subband coefficients are inputted into the digital watermark extraction unit, on the other hand, in FIG. 29, image data transformed to space area is inputted into the digital watermark extraction unit. The space area image data is an image signal decoded based on the LL subband coefficients.

The basic operation of the digital watermark extraction unit is the same in FIGS. 22 and 29, however, the pattern array employed for digital watermark extraction in FIG. 29 is different from that in FIG. 22. In the digital watermark extraction unit in FIG. 22, a frequency area pattern array as shown in FIG. 7 is used, whereas in the digital watermark extraction unit in FIG. 29, a space area pattern array as shown in FIG. 28 is used.

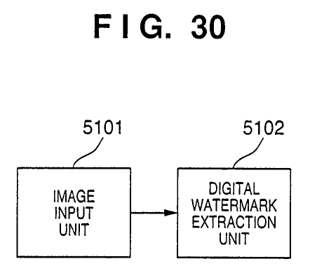

Next, a digital watermark extraction device which extracts a digital watermark from image data generated by the apparatus having the construction in FIG. 14 will be described with reference to FIG. 30. In FIG. 30, numeral 5101 denotes an image input unit; and 5102, a digital watermark extraction unit.

The difference between FIG. 15 and FIG. 30 is that image data discrete-wavelet transformed by the discrete wavelet transform unit 1502 is inputted into the digital watermark extraction unit in FIG. 15, whereas image data is directly inputted from the image input unit 5101 into the digital watermark extraction unit in FIG. 30. That is, in FIG. 15, LL subband coefficients transformed to frequency area are inputted into the digital watermark extraction unit, on the other hand, in FIG. 30, image data in space area is inputted into the digital watermark extraction unit. The basic operation of the digital watermark extraction unit is the same in FIGS. 15 and 30, however, the pattern array employed for digital watermark extraction in FIG. 30 is different from that in FIG. 15. In the digital watermark extraction unit in FIG. 15, a frequency area pattern array as shown in FIG. 7 is used, whereas in the digital watermark extraction unit in FIG. 30, a space area pattern array as shown in FIG. 28 is used.

As described above, the digital watermark extraction is not limited to the frequency area but can be performed in the space area.

Further, it is possible to extract a digital watermark embedded by using the first and second embodiments (embedded in a frequency area) by using the present embodiment (in a space area).

<Modification>

In the above embodiments, information obtained by error-correction coding may be used as the additional information Inf. This information further improves the reliability of extracted additional information Inf.

### Other Embodiment

The present invention can be applied to a part of a system constituted by a plurality of devices (e.g., a host computer, an interface, a reader and a printer) or to a part of an apparatus comprising a single device (e.g., a copy machine or a facsimile apparatus).

Further, the present invention is not limited to the apparatus and method for realizing the above-described embodiments. The present invention includes a case where the above-described embodiments are realized by providing software program code for realizing the above-described embodiments to a computer (CPU or MPU) in the system or apparatus, and operating the respective devices by the computer of the system or apparatus in accordance with the program code.

In this case, the program code itself of the software realizes the functions according to the above-described embodiments, and the program code itself, means for supplying the program code to the computer, more particularly, a storage medium holding the program code are included in the scope of the invention.

Further, as the storage medium holding the program code, a floppy disk, a hard disk, an optical disk, a magneto-optical disk, a CD-ROM, a CD-R, a magnetic tape, a non-volatile type memory card, a ROM and the like can be used.

Furthermore, besides aforesaid functions according to the above embodiments are realized by controlling the respective devices by the computer in accordance with only the supplied program code, the present invention includes a case where the above-described embodiments are realized by an OS (operating system) working on the computer, or the OS in cooperation with another application soft or the like.

Furthermore, the present invention also includes a case where, after the supplied program code is stored in a function expansion board of the computer or in a memory provided in a function expansion unit which is connected to the computer, a CPU or the like contained in the function expansion board or unit performs a part or entire actual processing in accordance with designations of the program code and realizes the above-described embodiments.

Further, a construction including at least one of the above-described various features is included in the present invention.

As described above, according to the present invention, image coding, digital watermark embedding, decoding and digital watermark extraction can be efficiently performed.

The present invention is not limited to the above embodiments and various changes and modifications can be made within the spirit and scope of the present invention. Therefore, to appraise the public of the scope of the present invention, the following claims are made.

1-42. (canceled)

43. An image processing apparatus comprising:
input means for inputting image data obtained by transforming an image into a plurality of frequency subbands, embedding a digital watermark into at least one subband by using a first pattern array, and inverse transforming the plurality of subbands; and
extraction means for extracting the digital watermark from the image data using a second pattern array.

44. The image processing apparatus according to claim 43, wherein said extraction means performs the digital watermark extraction, using a mask indicating a portion of the image data, in which respective bits constructing information to be embedded are embedded.

45. The image processing apparatus according to claim 43, wherein said extraction means performs convolution calculation between the second pattern array designating a change amount and the image data for the portion designated based on said mask on respective bits constructing information to be embedded, and performs the digital watermark extraction in correspondence with the result of calculation.

46. The image processing apparatus according to claim 45, wherein said extraction means obtains an index based on the result of the calculation, and specifies the embedded information in correspondence with the value of the index.

47. The image processing apparatus according to claim 43, wherein the second pattern array is obtained by performing inverse frequency transform on the first pattern array.

48. The image processing apparatus according to claim 43, wherein the digital watermark embedding is performed by using a patchwork method.

49. The image processing apparatus according to claim 43, wherein information to be embedded includes information obtained by error-correction coding.

50. An image processing apparatus comprising:
inverse discrete wavelet transform means for performing inverse discrete wavelet transform on a pattern array; and
digital watermark embedding means for performing digital watermark embedding by changing a portion of image data designated based on a mask by using the pattern array inverse discrete-wavelet transformed by said inverse discrete wavelet transform means.

51. The image processing apparatus according to claim 50, wherein said digital watermark embedding means performs the digital watermark embedding, using the mask designating the portion of the selected image data in which respective bits constructing information to be embedded are to be embedded.

52. The image processing apparatus according to claim 51, wherein said digital watermark embedding means further performs the digital watermark embedding by changing the portion designated based on the mask by using the pattern array designating a change amount.

53. The image processing apparatus according to claim 52, wherein said digital watermark embedding means performs addition and/or subtraction on the pattern array corresponding to the portion designated based on the mask, in correspondence with values of the respective bits constructing the information to be embedded.

54. The image processing apparatus according to claim 50, wherein said digital watermark embedding means performs the digital watermark embedding based on a patchwork method.

55. An image processing method comprising:
an input step of inputting image data obtained by transforming an image into a plurality of frequency subbands, embedding a digital watermark into at least one subband by using a first pattern array, and inverse transforming the plurality of subbands; and
an extraction step of extracting the digital watermark from the image data using a second pattern array.

56. An image processing method comprising:
an inverse discrete wavelet transform step of performing inverse discrete wavelet transform on a pattern array; and
a digital watermark embedding step of performing digital watermark embedding by changing a portion of image data designated based on a mask by using the pattern array inverse discrete-wavelet transformed in said inverse discrete wavelet transform step.

57. Program, embodied in a computer-readable medium, for executing the image processing method according to claim 55.

58. A computer-readable storage medium holding the program code according to claim 57.

59. Program, embodied in a computer-readable medium, for executing the image processing method according to claim 56.

60. A computer-readable storage medium holding the program code according to claim 59.
